(19) United States
(12) Patent Application Publication
(10) Pub. No.: US 2014/0023413 A1
(43) Pub. Date: Jan. 23, 2014

(54) IMAGE HEATING APPARATUS

(71) Applicant: CANON KABUSHIKI KAISHA, Tokyo (JP)

(72) Inventors: Takeshi Shinji, Boise, ID (US); Satoshi Nishida, Numazu-shi (JP); Takanori Mitani, Tokyo (JP); Shogo Kan, Suntou-gun (JP)

(21) Appl. No.: 13/944,126

(22) Filed: Jul. 17, 2013

(30) Foreign Application Priority Data
Jul. 19, 2012 (JP) 2012-160326
Jun. 6, 2013 (JP) 2013-119773

(51) Int. Cl. G03G 15/20

(52) U.S. Cl. CPC G03G 15/2057
USPC 399/329

(57) ABSTRACT

The image heating apparatus, for heating a toner image while conveying a recording material bearing the toner image at a nip portion, includes a rotary member in contact with the toner image, an endless belt, and a nip portion forming member that is in contact with the inner surface of the belt and forms the nip portion together with the rotary member via the belt. The nip portion forming member is a metal member having a surface which is in contact with the inner surface of the belt and on which an oxide layer is formed by an alumite treatment.

### BACKGROUND OF THE INVENTION

1. Field of the Invention

The present invention relates to image heating apparatuses mounted on image forming apparatuses, such as electrophotographic printers and copiers.

2. Description of the Related Art

External heating fixing units have been known as image heating apparatuses mounted on electrophotographic printers and electrophotographic copiers.

Japanese Patent Application Laid-Open No. 2004-279857 discloses a fixing unit including: a fixing roller that comes into contact with an image on a recording material and heats the image; a cylindrical belt; and a nip portion forming member (pressure pad) that comes into contact with the inner circumferential surface of the belt and forms a nip portion with the fixing roller via the belt. The recording material bearing an unfixed toner image is heated while being sandwiched and conveyed at the nip portion. The heating fixes the unfixed toner image on the recording material.

If thermal insulative material is used for as in the fixing unit in Japanese Patent Application Laid-Open No. 2004-279857, they cause the following problems. If a small-sized recording material is successively fixed at high speed, the temperature of a region of the fixing roller and the belt where no recording material passes (non-sheet feeding area) excessively increases, which is called the non-sheet feeding area temperature rise. The fixing roller and the belt may be damaged by heat. In particular, as with the fixing unit in Japanese Patent Application Laid-Open No. 2004-279857, if a sliding layer that has a low thermal conductivity and is made of one of a glass coat and fluorocarbon polymer is provided on a base member of a pressure pad for securing slidability between the nip portion forming member (pressure pad) and the inner surface of the belt, heat at the fixing roller and the belt is difficult to be released to the base member of the pressure pad, and the non-sheet feeding area temperature rise is difficult to be alleviated. Since the base member of the pressure pad is made of one of rubber and resin for securing thermal insulation, the thermal conductivity is low. Accordingly, the non-sheet feeding area temperature rise is difficult to be alleviated.

In contrast, if no sliding layer is provided on the pressure pad, the heat of the fixing roller and the belt is easily conducted to the nip portion forming member. However, the slidability between the nip portion forming member and the inner surface of the belt is reduced, and the nip portion forming member and the belt are abraded to generate dust. The dust further reduces the slidability. As a result, a torque for driving the fixing roller may increase, and an unusual noise may occur owing to a stick slip phenomenon.

Thus, as described above, in the external heating fixing unit, reduction in slidability between the nip portion forming member and the inner surface of the belt should desirably be avoided, while the non-sheet feeding area temperature rise is suppressed.

It is an object of the present invention to provide an image heating apparatus that can suppress reduction in slidability between the nip portion forming member and the inner surface of the belt while suppressing the non-sheet feeding area temperature rise.

### SUMMARY OF THE INVENTION

The present invention is provided with an image heating apparatus for heating a toner image while conveying a recording material bearing the toner image at a nip portion, including a rotary member configured to contact the toner image, an endless belt, and a nip portion forming member configured to contact with an inner surface of the belt and form the nip portion together with the rotary member through the belt, wherein the nip portion forming member is made of metal whose surface which contacts the inner surface of the belt has an oxide layer formed by an alumite treatment.

The present invention is provided with an image heating apparatus for heating a toner image while conveying a recording material bearing the toner image a nip portion, including an endless belt configured to contact the toner image, a nip portion forming member configured to contact an inner surface of the belt, and a pressure member forming the nip portion together with the nip portion forming member through the belt wherein the nip portion forming member is made of metal whose surface which contacts the inner surface of the belt has an oxide layer formed by an alumite treatment.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus according to Embodiment 1.

FIG. 2 is a schematic cross-sectional view of a fixing unit according to Embodiment 1.

FIG. 3 is a front view of a fixing unit according to Embodiment 1 from a recording material introducing side.

FIG. 4 is a cross-sectional view of a contact region between a nip portion forming member and a pressure film of the fixing unit according to Embodiment 1.

FIG. 5 is a schematic cross-sectional view of a fixing unit according to a variation of Embodiment 1.

FIG. 6A is a cross-sectional view of a fixing unit according to Embodiment 2.

FIG. 6B is a sectional view of a contact region between a nip portion forming member and a pressure film of the fixing unit according to Embodiment 2.

### DESCRIPTION OF THE EMBODIMENTS

Preferred embodiments of the present invention will now be described in detail in accordance with the accompanying drawings.

### Embodiment 1

(1) Image Forming Apparatus

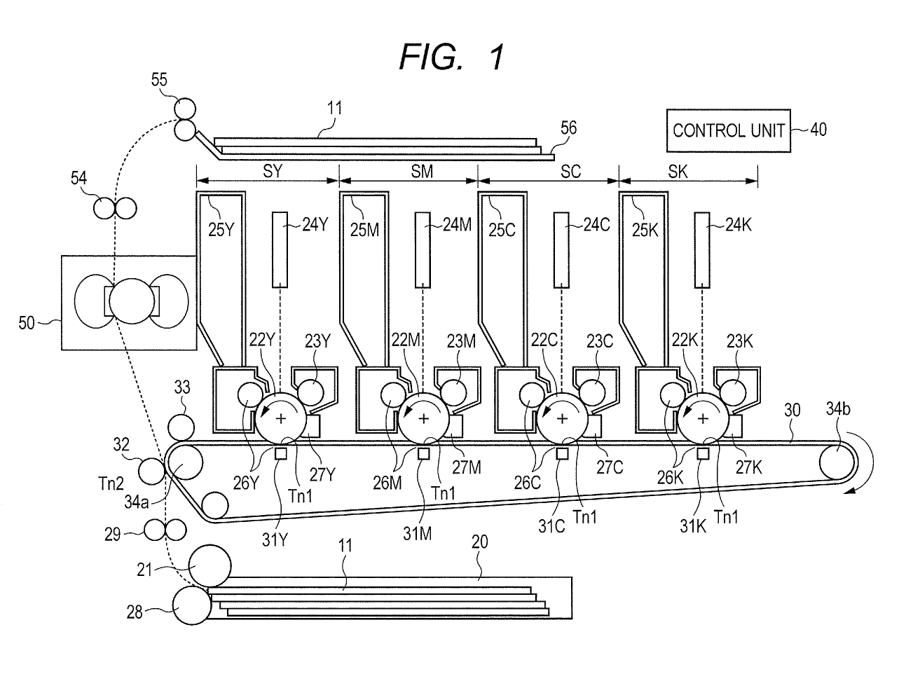

FIG. 1 is a schematic sectional view of an image forming apparatus according to Embodiment 1. The image forming apparatus of Embodiment 1 is an in-line full-color laser printer.

The image forming apparatus described in this embodiment includes: an image forming unit 10 that forms an unfixed toner image on a recording material; and a fixing unit 50 that fixes the toner image formed on the recording material. The fixing unit 50 includes a fixing unit that will be described in (2).

The image forming unit 10 is provided with four image forming stations SY, SM, SC and SK arranged along the rotational direction of an intermediate transfer belt 30, which is an intermediate transfer medium, from an upstream side to a downstream side. The image forming stations SY, SM, SC and SK form yellow, magenta, cyan and black toner images, respectively.

The image forming stations SY, SM, SC and SK include respective photosensitive drums 22Y, 22M, 22C and 22K, which are image bearers. A driving force of a drive motor (not illustrated) is transmitted to the photosensitive drums, which are driven in the directions of respective arrows.

Chargers 23Y, 23M, 23C and 23K and exposure portions 24Y, 24M, 24C and 24K are arranged around the respective photosensitive drums 22Y, 22M, 22C and 22K along the rotational directions of the photosensitive drums. Furthermore, developers 26Y, 26M, 26C and 26K, primary transfer portions 31Y, 31M, 31C and 31K, and cleaners 27Y, 27M, 27C and 27K are arranged around the respective photosensitive drums 22Y, 22M, 22C and 22K.

Furthermore, toner cartridges 25Y, 25M, 25C and 25K for supplying the developers with toner are arranged above the respective developers 26Y, 26M, 26C and 26K.

The intermediate transfer belt 30 is an endless belt made of resin. The intermediate transfer belt 30 is laid with a tension around three rotatable support members, which are a drive roller 34a, a secondary transfer opposite roller 34b and a tension roller 34c. The peripheral surface of the intermediate transfer belt 30 is in contact with the peripheral surfaces of the photosensitive drums 22Y, 22M, 22C and 22K. This contact forms primary transfer nip portions Tn1 between the surface of the intermediate transfer belt 30 and the surfaces of the respective photosensitive drums 22Y, 22M, 22C and 22K. The driving force of the drive motor is transmitted to the intermediate transfer belt 30, which is driven to rotate in the direction of an arrow.

A secondary transfer roller 32 is arranged to be opposite to the secondary transfer opposite roller 34b; the intermediate transfer belt 30 intervenes between the rollers. The peripheral surface (outer face) of the secondary transfer roller 32 is in contact with the surface of the intermediate transfer belt 30, thereby forming a secondary transfer nip portion Tn2.

A control unit 40 includes a CPU and memories, such as RAM and ROM. The memories are stored with a control sequence for forming an image. The control unit 40 executes the control sequence for forming an image according to a print instruction output from an external device (not illustrated), such as a host computer, to control the image forming unit 10 and the fixing unit 50.

Upon execution of the image forming control sequence, the image forming apparatus of this embodiment rotates the photosensitive drum 22Y in the direction of the arrow at the image forming station SY.

First, the surface of the photosensitive drum 22Y is charged by the charger 23Y uniformly to a prescribed polarity and potential (charging step). The exposure portion 24Y irradiates the charged surface of the photosensitive drum 22Y with laser light according to image data input from the external device, thereby forming an electrostatic latent image on the photosensitive drum 22Y (exposure step). The developer 26Y realizes the electrostatic latent image with toner to form a toner image (developing step). The toner image is thus formed on the surface of the photosensitive drum 22Y.

Also at the image forming stations SM, SC and SK, an image forming process including analogous charging, exposure and developing steps is also performed, thereby forming toner images on the surfaces of the respective photosensitive drums 22Y, 22M, 22C and 22K.

The toner image formed on the photosensitive drum 22Y is transferred on the surface of the intermediate transfer belt 30 at the primary transfer nip portion Tn1 with a prescribed voltage applied to the primary transfer portion 26Y (primary transfer step). Likewise, the toner images with respective colors on the photosensitive drums 22M, 22C and 22K are transferred onto the surface of the intermediate transfer belt 30 at the respective primary transfer nip portions Tn1 in an overlapping manner. The transfer forms four-full-colored unfixed toner images on the surface of the intermediate transfer belt 30.

After the primary transfer, transfer remaining toner on the surfaces of the respective photosensitive drums 22Y, 22M, 22C and 22K is removed by the respective cleaners 27Y, 27M, 27C and 27K. The photosensitive drums 22Y, 22M, 22C and 22K are thus prepared for a next image formation.

Meanwhile, recording materials 11 stacked and stored in a feed cassette 20 arranged below the intermediate transfer belt 30 are separated one by one from the feed cassette 20 by a feed roller 21 and a retard roller 28 and fed to a registration rollers 29. The registration rollers 29 convey the fed recording material to the secondary transfer nip portion Tn2. The recording material 11 is sandwiched by the secondary transfer nip portion Tn2 and conveyed. A prescribed voltage is applied to the secondary transfer roller 32 in the conveying process, thereby transferring the unfixed toner image on the surface of the intermediate transfer belt 30 onto the recording material 11 (secondary transfer step).

The recording material 11 on which the unfixed toner image is formed is introduced into the fixing unit 50. During passing through the fixing unit 50, the unfixed toner image is subjected to heat and pressure and fixed on the recording material. The recording material 11 having passed through the fixing unit 50 is conveyed by ejection rollers 54 and 55 and ejected onto an ejection tray 56.

After the secondary transfer, the transfer remaining toner on the surface of the intermediate transfer belt 30 is charged by a charging roller for transfer remaining toner to the polarity opposite to the polarity for forming an image. The toner is collected by the primary transfer portions 31 owing to an electrostatic force onto the surfaces of the respective photosensitive drums 22Y, 22M, 22C and 22K, and, in turn, collected by the cleaners 27Y, 27M, 27C and 27K.

(2) Fixing Unit 50

In the following description, as to the fixing unit and the components configuring the fixing unit, a longitudinal direction is orthogonal to a recording material conveyance direction on the plane of the recording material. A short direction is parallel to the recording material conveyance direction in the plane of the recording material. A longitudinal width is a width in the longitudinal direction. A short width is a width in the short direction. As to the recording material, a short direction is parallel to the recording material conveyance direction on the plane of the recording material. A widthshort width is a width in the short direction.

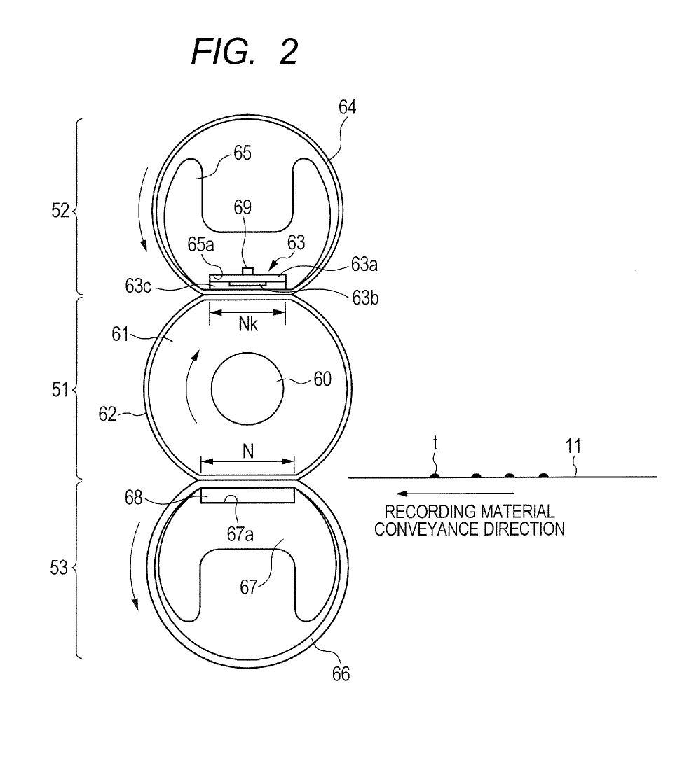

FIG. 2 is a schematic sectional view of the fixing unit 50 according to this embodiment. FIG. 3 is a front view of the fixing unit 50 illustrated in FIG. 2 from a recording material introducing side. The fixing unit 50 is an external heating fixing unit.

The fixing unit 50 illustrated in this embodiment includes: a fixing roller 51 that is a rotary member comes into contact with an image on a recording material and heats the image; a heating portion 52; and a pressure portion 53.

The fixing roller 51 includes a core metal 60 that is made of a metal material, such as iron, SUS or aluminum, and has a cylindrical shaft shape. An elastic layer 61 made mainly of silicone rubber is formed on the peripheral surface of the core metal 60. A release layer (outermost layer) 62 made mainly of one of PTFE, PFA and FEP is formed on the peripheral surface of the elastic layer 61.

Here, PTFE is polytetrafluoroethylene. PFA is tetrafluoroethylene/perfluoroalkyl vinyl ether copolymer. FEP is fluorinated ethylene propylene copolymer.

The fixing roller 51 is a long member, defining the longitudinal direction. The opposite ends of the core metal 60 in the longitudinal direction are rotatably supported by a device frame (not illustrated) of the fixing unit.

The heating portion 52 includes: a ceramic heater (hereinafter, called a heater) 63; a heating film (belt) 64 that has a cylindrical shape and is rotatable; and a heating film guide 65 as a support member. Each of the heater 63, the heating film 64 and the heating film guide 65 is a long member, defining the longitudinal direction.

The heating film guide 65, which is made of a heat-resistant resin material and substantially has a gutter cross section, supports the heater 63 at a concave 65a formed along the longitudinal direction. The heating film 64 is loosely fitted over the outer periphery of the heating film guide 65. The heating film 64 includes: a base layer formed of polyimide resin; and a release layer formed of fluorocarbon polymer, such as PFA, on the peripheral surface of the base layer.

The opposite ends of the heating film guide 65 in the longitudinal direction are supported by the device frame, and pressed by a pressing spring (not illustrated) in the perpendicular direction orthogonal to the base line direction of the fixing roller 51. Thus, the heater 63 is pressed against the fixing roller 51 via the heating film to elastically deform the elastic layer 61 along the longitudinal direction of the heater 63, thereby forming a heating pressure area Nk between the surface of the fixing roller 51 and the surface of the heating film 64; this area has a prescribed width.

The heater 63 includes a long and narrow ceramic substrate 63a having a rectangular cross-section. A heating resistor 63b made of Ag/Pd (silver-palladium) is formed by screen printing along the longitudinal direction of the substrate 63a on a surface of the substrate 63a facing the surface of the heating pressure area Nk. A cover layer 63c is formed on the surface of the substrate 63a so as to cover the heating resistor 63b. The heating resistor 63b is supplied with electricity to generate heat.

The pressure portion 53 includes: a nip portion forming member 68; a pressure film (endless belt) 66 that has a cylindrical shape and is rotatable; and a pressure film guide (support member) 67. Each of the nip portion forming member 68, the pressure film 66 and the pressure film guide 67 is a long member, defining the longitudinal direction.

The nip portion forming member 68 is formed to have a rectangular cross-section. The pressure film guide 67, which is made of heat-resistant resin material and substantially has a reversed gutter cross section, supports the nip portion forming member 68 at a concave 67a formed along the longitudinal direction. The pressure film 66 is loosely fitted over the outer periphery of the pressure film guide 67. The pressure film 66 includes: a base layer formed of polyimide resin; and a release layer formed of fluorocarbon polymer, such as PFA, on the peripheral surface of the base layer. The base layer of the pressure film 66 is in contact with the nip portion forming member 68.

The opposite ends of the pressure film guide 67 in the longitudinal direction are supported by the device frame, and pressed by a pressing spring (not illustrated) in the perpendicular direction orthogonal to the base line direction of the fixing roller 51. Thus, the nip portion forming member 68 is pressed against the fixing roller 51 via the pressure film 66, and the elastic layer 61 is elastically deformed along the longitudinal direction of the nip portion forming member 68, thereby forming a fixing nip portion N.

Fluorinated grease is applied as lubricant to the inner surfaces of the heating film 64 and the pressure film 66 to reduce the rotational torque.

In the fixing unit 50 of this embodiment, a motor (not illustrated) is rotationally driven according to the print instruction. The rotation of an output shaft of the drive motor is transmitted to the core metal 61 of the fixing roller 51 via a prescribed gear mechanism (not illustrated). Thus, the fixing roller 51 rotates in the direction of an arrow.

The rotation of the fixing roller 51 is transmitted to the heating film 64 owing to a frictional force generated between the surface of the fixing roller 51 and the surface of the heating film 64 in the heating pressure area Nk. Thus, the heating film 64 follows the rotation of the fixing roller 51 to rotate in the direction of an arrow while being in contact with the cover layer 63c of the heater 63. The rotation of the fixing roller 51 is transmitted at the fixing nip portion N to the pressure film 66 owing to the frictional force between the surface of the fixing roller 51 and the surface of the pressure film 66. Thus, the pressure film 66 follows the rotation of the fixing roller 51 to rotate in the direction of an arrow while being in contact with the nip portion forming member 68.

Furthermore, a triac, as a bidirectional thyristor, starts to supply electricity to the heater 63 according to the print instruction. The heating resistor 63b is supplied with electricity, which allows the heater 63 to rapidly generate heat and to heat the inner surface of the heating film 64. Thus, the heating film 64 heats the surface of the fixing roller 51.

The temperature of the heater 63 is detected by a thermistor S that is a temperature detecting element provided on the rear surface of the substrate 63a other than the heating pressure area Nk. The control unit 40 captures a detection signal (output signal) from the thermistor S. The triac determines the duty ratio and wave number of the voltage to be applied to the heating resistor 63b based on the detection signal to perform control, and maintains the detection temperature to be a fixing temperature (target temperature) of the heater 63.

In a state where the fixing roller 51 is rotatably driven and the heater 63 is maintained at the fixing temperature, the recording material 11 on which the unfixed toner image t is formed is introduced into the fixing nip portion N while a toner forming surface faces the fixing roller 51. The recording material 11 sandwiched at the fixing nip portion N and conveyed, and the unfixed toner image t is subjected to heat and pressure of the heater 63 and fixed on the recording material. The recording material 11 on which the unfixed toner image t is fixed is ejected from the fixing nip portion N.

(3) Nip Portion Forming Member 68

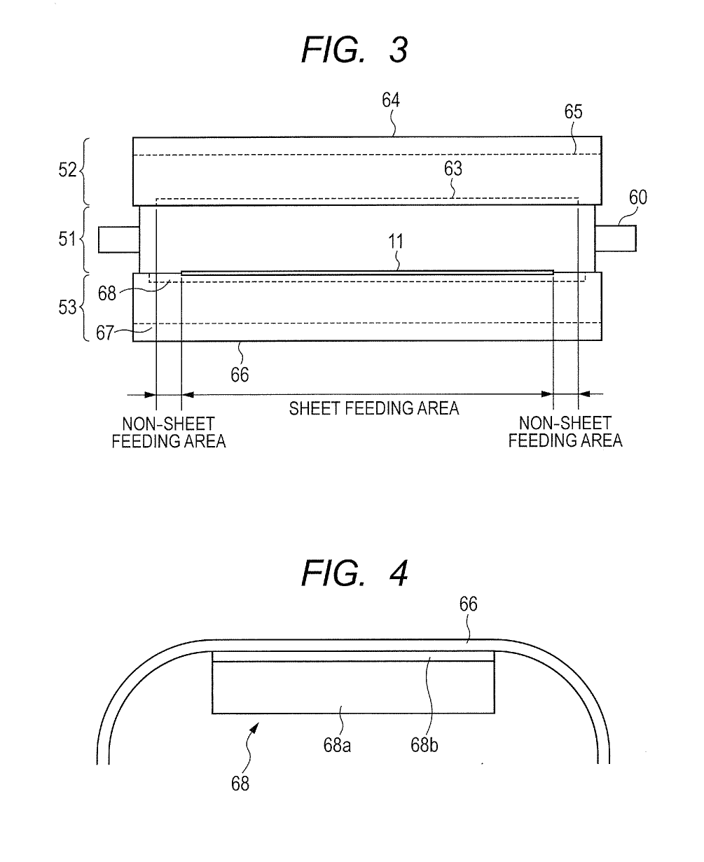

Next, referring to FIG. 4, the nip portion forming member 68 will be described in detail. FIG. 4 is a cross-sectional view of the contact region between the nip portion forming member 68 and the pressure film 66.

The nip portion forming member 68 is in contact with the inner surface (base layer) of the pressure film 66, and presses the pressure film 66 toward the fixing roller 51.

As illustrated in FIG. 3, the longitudinal width of the nip portion forming member 68 is longer than the longitudinal width of the heater 63, and the longitudinal width of the heater 63 is longer than the short width of the recording material 11. Accordingly, in a region of the heater 63 on the outside of the short width of the recording material 11, heat supplied by the heater 63 is not absorbed by the recording material 11 and the unfixed toner image t on the recording material 11 but is accumulated in the configurational components, such as the fixing roller 51 and the heating film guide 65.

The temperature in a region (hereinafter, called non-sheet feeding area) of the heater 63 outside of a region where the recording material 11 passes (sheet feeding area) tends to excessively increase. This phenomenon is called “the non-sheet feeding area temperature rise” (see FIG. 3). The components configuring the fixing unit have respective heat-resistant limit temperatures. When the fixing unit is use at a temperature exceeding the heat-resistant limit temperature, it may break the component. Thus, it is required to use the device at or below the heat-resistant limit temperature. The shorter the width of the recording material 11 with respect to the longitudinal width of the heater 63, the more significantly the non-sheet feeding area temperature rise occurs. Thus, measures for conveying the recording materials 11 at intervals are required, which reduces productivity of forming images.

Adoption of a metal with a high thermal conductivity as the nip portion forming member 68 exerts an advantageous effect of uniformizing unevenness in temperature in the longitudinal direction. A mechanism allowing the nip portion forming member 68 to uniformize unevenness in temperature, and a thermal conduction path will be described.

In the sheet feeding area of the recording material 11, the heat of the fixing roller 51 is absorbed by the recording material 11, and the heat of the nip portion forming member 68 is also absorbed by the recording material 11. Accordingly, the temperature in the non-sheet feeding area of the nip portion forming member is difficult to increase. Meanwhile, since no recording material 11 exists in the non-sheet feeding area of the recording material 11, the heat of the fixing roller 51 is directly conducted to the pressure film 66, and the heat of the pressure film 66 is, in turn, conducted to the nip portion forming member 68. Accordingly, the temperature distribution of the nip portion forming member 68 has a tendency where the temperature is high in the non-sheet feeding area and the temperature in the sheet feeding area is lower than that of the non-sheet feeding area. As a result, the heat in the non-sheet feeding area of the nip portion forming member 68 is transferred to the sheet feeding area having a relatively lower temperature than the non-sheet feeding area has in the nip portion forming member 68. The heat having being conducted to the sheet feeding area of the nip portion forming member 68 is, in turn, conducted to the recording material 11, and excessive increase in temperatures of the fixing roller 51 and the pressure film 66 in the non-sheet feeding area can be suppressed. Even on a small-sized recording material 11, images can be sequentially formed as with the case on large-sized recording materials.

To suppress the non-sheet feeding area temperature rise according to the above method, it is important to increase the thermal conductivity of the nip portion forming member 68 and reduce the thermal resistance between the pressure film 66 and the nip portion forming member 68.

Here, a case of adopting aluminum as the base member of the nip portion forming member 68 will be described. Aluminum is suitable for the nip portion forming member because aluminum has a high thermal conductivity and can be easily surface-finished among metal members. The thermal conductivity of pure aluminum with an aluminum content percentage of at least 99.0 wt % is about 235 W/m·K. The thermal diffusivity and specific heat are measured by a laser flash method thermal property measuring instrument LFA-502 (made by Kyoto Electronics Manufacturing), and the density is measured by an electronic balance high precision hydrometer (product by AS ONE); the thermal conductivity is calculated using the measured thermal diffusivity, specific heat and specific gravity. Measurement of the thermal conductivity causes a measurement error of about ±10%.

Table 1 illustrates the materials and thermal conductivities of nip portion forming members 68, and output speeds in the case where 100 sheets of A4 or B5-sized recording paper are successively introduced into the fixing nip portion N (sheet feeding).

The output speed is a speed at the time when the 100th sheet is fed while the heat-resistant limit temperature of each component is adjusted not to be exceeded; the speed is represented as a relative value with reference to a speed for pure aluminum. To focus only on difference of material, the shapes of nip portion forming members 68 are the same. The image forming apparatus according to this embodiment can accept an LTR size (width of 215.9 mm) at the maximum. The width of the heater 63 is designed in conformity to the size. Accordingly, although a little, the non-sheet feeding area temperature rise occurs even for an A4 size (width of 210 mm). The increase is obvious for a B5 size (width of 182 mm).

As illustrated in Table 1, for an A4 size, an output speed equivalent to the speed for pure aluminum can be achieved by setting the thermal conductivity of the nip portion forming member 68 to at least 110 W/m·K. For a B5 size, the non-sheet feeding area temperature rise is more obvious. Accordingly, an output speed equivalent to the speed for pure aluminum can be achieved by setting the thermal conductivity of the nip portion forming member 68 to at least 180 W/m·K.

TABLE 1

| Material of nip | Thermal | | |
|---|---|---|---|
| portion forming | conductivity | Output speed | |
| member 68 | (W/m · K) | A4 size | B5 size |
| Pure aluminum | 225 | Reference | Reference |
| Aluminum alloy (A6061) | 180 | 1.0 | 1.0 |
| Aluminum alloy (A2017) | 130 | 1.0 | 0.8 |
| Aluminum alloy (A5057) | 110 | 1.0 | 0.7 |
| Alumina | 40 | 0.9 | 0.5 |
| Stainless steel (SUS304) | 17 | 0.9 | 0.4 |
| Glass | 1 | 0.7 | 0.3 |

Even a material, such as stainless steel, having a lower thermal conductivity than pure aluminum has can exert an advantageous effect of uniformizing unevenness in temperature in the longitudinal direction in comparison with a material, such as glass, having a low thermal conductivity. However, if pure aluminum having a high thermal conductivity is adopted as the base member of the nip portion forming member, a great advantageous effect of suppressing the non-sheet feeding area temperature rise is exerted.

Increase in the cross-sectional area of the nip portion forming member 68 also increases the advantageous effect of uniformizing unevenness in temperature. However, the heat capacity of the nip portion forming member 68 is increased. Accordingly, the temperature of the fixing roller 51 is difficult to increase. Thus, the time until the temperature of the fixing roller 51 reaches the fixing temperature increases. In particular, a time until a first image is output (FPOT: first print out time) unfortunately increases. Thus, the higher thermal conductivity of the material is adopted for the nip portion forming member 68, the smaller the cross-sectional area is. This relationship can achieve both a high output speed (high productivity) and reduction in FPOT.

As described above, a material for the nip portion forming member 68 that has a thermal conductivity necessary for this embodiment, is relatively inexpensive and has general versatility is one of aluminum and aluminum alloys. However, if the pressure film 66 made of resin such as polyimide is in slidable contact with the nip portion forming member 68 made of a metal, such as aluminum, the surface of the nip portion forming member 68, and the inner surface of the pressure film 66 may unfortunately be scraped.

Sliding contact with the pressure film 66 scratches the surface of the nip portion forming member 68. Generated aluminum dust further scratches the surfaces of the pressure film 66 and the nip portion forming member 68, thereby aggravating scraping. Dust of aluminum and polyimide absorbs lubricant applied to the inner surface of the pressure film 66, and reduces the slidability.

If the slidability between the pressure film 66 and the nip portion forming member 68 is reduced, the drive torque of the fixing roller 51 increases, unusual noise occurs owing to a stick slip phenomenon, and the pressure film 66 is stopped. Accordingly, the recording material 11 slips on the fixing roller 51 and, unfortunately, cannot be conveyed.

Conventionally, the surface of the nip portion forming member sliding on the inner surface of the pressure film 66 made of resin such as polyimide is covered with one of a glass layer, a resin layer (one of fluorocarbon polymer, polyimide resin and aramid resin) and a resin sheet. Thus, the components do not scratch each other, thereby securing slidability.

However, the thermal conductivity of a resin, such as one of fluorocarbon polymer, polyimide and aramid resin is about 0.3 W/m·K, which is very low. The thermal conductivity of glass is about 1 W/m·K, which is also very low. Typically, the sliding cover layer has a thickness of about 20-30 μm for a fluorocarbon polymer layer, or a thickness of about 60 μm for glass. The layer does not have a good thermal conductivity.

If the surface of the nip portion forming member 68 in contact with the pressure film 66 has a high thermal resistance, excessive heat of the fixing roller 51 and the pressure film 66 in the non-sheet feeding area is difficult to be conducted to the nip portion forming member 68 when a small-sized recording sheet is fed. Furthermore, heat of the nip portion forming member 68 in the sheet feeding area is difficult to be conducted to the recording material. Even if the nip portion forming member 68 is made of a material with a high thermal conductivity, the high thermal conductivity cannot be sufficiently utilized, and an advantageous effect of suppressing the non-sheet feeding area temperature rise cannot be sufficiently exerted.

In this embodiment, pure aluminum (A1050) with an aluminum content percentage of at least 99.0 wt % is adopted for the base member 68a of the nip portion forming member 68. An alumite treatment, which is an anodic oxidation treatment on aluminum, is applied to aluminum, thereby forming an oxide layer 68b at least on a surface of the base member 68a slidable on the inner surface of the pressure film 66 (see FIG. 4). The nip portion forming member 68 includes the base member 68a made of pure aluminum, and the oxide layer 68b formed on the surface of the nip portion forming member 68 facing the pressure film 66. The alumite treatment is a method of electrochemically oxidizing a surface of aluminum using an electrolytic solution, such as of one of sulfuric acid and oxalic acid, to generate an Al₂O₃ (alumina) film. The oxide layer 68b functions as a layer of covering the surface of the nip portion forming member 68, which is easily scratched by sliding.

The oxide layer 68b has a thermal conductivity of about 60 W/m·K, which is higher than the thermal conductivity of one of glass and fluorocarbon polymer. If the oxide layer 68b has a thickness of 50 μm or less, an effect on the thermal transmission from the pressure film 66 to the nip portion forming member 68 can be sufficiently small. Accordingly, an advantageous effect of suppressing the non-sheet feeding area temperature rise can be sufficiently exerted.

According to the shape of the surface of the oxide layer 68b in contact with the inner surface of the pressure film 66, the advantageous effect of suppressing the non-sheet feeding area temperature rise varies. Here, an indicator, skewness Rsk, will be described. The skewness Rsk is an indicator representing a deviation from the center line of a roughness curve, and calculated by the following expression.

$$Rsk = \frac{1}{{Rq}^{3}} [ \frac{1}{Ir} {\int }_{0}^{Ir} {z}^{3} ( x ) d x ]$$

In the expression, Z(x) represents a roughness curve, Rq represents a root mean squire roughness, and lr represents a reference length (see Japanese Industrial Standards B0601). In the case of Rsk<0, the height distribution deviates upward from the center line. In the case of Rsk>0, the height distribution deviates downward from the center line.

In this embodiment, in the case where distal convex ends on the surface of the oxide layer 68b have a sharper profile than concave bottoms have, a skewness Rsk easily satisfies Rsk>0. In contrast, in the case where the distal convex ends on the surface of the oxide layer 68b have a rounder profile than the concave bottoms have, the skewness Rsk easily satisfies Rsk<0. In the case where the distal convex ends has the same profile as that of the concave bottoms, the higher the density of the convexes, the easier Rsk<0 is satisfied, and, the lower the density of the convexes, the easier Rsk>0 is satisfied. That is, in the case where the skewness Rsk of the roughness curve of the surface of the oxide layer 68b satisfies Rsk<0, an area where the pressure film 66 is in contact with the oxide layer 68b is larger than the area in the case of satisfying Rsk>0. As a result, heat of the pressure film 66 with the non-sheet feeding area temperature rise is easily conducted to the oxide layer 68b. Accordingly, the advantageous effect of suppressing the non-sheet feeding area temperature rise increases.

Furthermore, in the case where the arithmetic average surface roughness of the surface of the oxide layer 68b is low, an area where the inner surface of the pressure film 66 is in contact with the oxide layer 68b increases. Accordingly, the advantageous effect of suppressing the non-sheet feeding area temperature rise increases.

The shape of the surface of the aluminum oxide film 66b varies according to the type of the electrolytic solution of the alumite treatment, temperature and treatment time. For instance, an oxide film subjected to sulfuric acid as an electrolytic solution is a porous film having innumerable micropores. This film is a honeycombed aggregate of hexagonal columnar cells. Each cell has a micropore at the center. This film has a higher arithmetic average surface roughness Ra than pure aluminum has.

For exerting the advantageous effect of suppressing the non-sheet feeding area temperature rise using the nip portion forming member 68 on which the oxide layer 68b is formed and which has a high thermal conductivity, it is important to manage the surface property.

As illustrated in Table 2, in the case where the skewness Rsk of the roughness curve of the nip portion forming member 68 is set to −1.0 or less, and the arithmetic average surface roughness Ra of the nip portion forming member 68 is set to 1.0 μm or less, an output speed equivalent to that of pure aluminum having not been subjected to an alumite treatment can be achieved for an A4 size.

TABLE 2

| | | | Surface | | |
|---|---|---|---|---|---|
| | Oxide | Thermal | rough- | | |
| Material of nip | layer | conduc- | ness | Skew- | |
| portion forming | thickness | tivity | Ra | ness | Output |
| member 68 | (μm) | ( W/m · K) | (μm) | Rsk | B5 size |
| Pure aluminum | 0 | 225 | 0.1 | 0 | Reference |
| Pure aluminum | 10 | 220 | 0.5 | −1.0 | 1.0 |
| (alumite treatment | | | | | |
| A) | | | | | |
| Pure aluminum | 20 | 215 | 0.5 | −1.0 | 1.0 |
| (alumite treatment | | | | | |
| B) | | | | | |
| Pure aluminum | 50 | 210 | 0.5 | −1.0 | 1.0 |
| (alumite treatment | | | | | |
| C) | | | | | |
| Pure aluminum | 50 | 210 | 1.0 | −1.0 | 1.0 |
| (alumite treatment | | | | | |
| D) | | | | | |
| Pure aluminum | 50 | 210 | 1.5 | −1.0 | 0.9 |
| (alumite treatment | | | | | |
| E) | | | | | |
| Pure aluminum | 50 | 210 | 0.5 | +0.5 | 0.9 |
| (alumite treatment | | | | | |
| F) | | | | | |

As described above, abrasion (scraping) on the surface of the nip portion forming member sliding with the pressure film 66 can be suppressed, by adopting the nip portion forming member where the oxide layer 68b is formed on the surface of the aluminum as the base member.

Next, the hardnesses of the oxide layer and the pressure film 66 will be described. According to measurement by a Vickers hardness meter MMT-X7 (made by Matsuzawa), polyimide as the base member of the pressure film 66 has a Vickers hardness of about 100 (test force: 0.049 N (5 gf)). Meanwhile, pure aluminum has a Vickers hardness of about 30 (test force: 0.98 N (100 gf). Here, the test force is set in conformity with a measurement target. In general, the Vickers hardness is independent from a test force. Even with different test forces and measurement targets, comparison can be made. However, measurement of a Vickers hardness has a measurement error due to an object of about ±10% at the maximum.

Table 3 illustrates relationship between the Vickers hardness on the surface of the nip portion forming member 68 and the scraping level due to sliding contact with the pressure film 66. In the case where the oxide layer 68b acquired by an alumite treatment had a Vickers hardness of at least 150 (test force 100 gf), scraping due to sliding with the pressure film 66 was allowable. This embodiment adopts a layer having a Vickers hardness of about 400 (test force 100 gf). The abrasion (scraping) of the surface of the nip portion forming member 68 due to sliding contact with the inner surface of the pressure film 66 is suppressed by increasing the hardness of the surface (oxide layer 68b) of the nip portion forming member 68. The base layer of the pressure film 66 that is made of the polyimide resin causes a very small quantity of dust due to sliding contact with the nip portion forming member 68. However, the dust exerts only a small adverse effect on the slidability.

TABLE 3

| | | Surface | |
|---|---|---|---|
| | | rough- | |
| Material of nip portion forming | Vickers | ness | |
| member 68 | hardness | Ra (μm) | Scraping |
| Pure aluminum | 30 | 0.1 | Fail (occurred) |
| Aluminum alloy (A6061) | 105 | 0.5 | Fair |
| Aluminum alloy (A2017) | 120 | 0.5 | Fair |
| Pure aluminum (alumite treatment A) | 150 | 0.5 | Not-occurred |
| Pure aluminum (alumite treatment B) | 200 | 0.5 | Not-occurred |
| Pure aluminum (alumite treatment C) | 400 | 0.5 | Not-occurred |
| Pure aluminum (alumite treatment D) | 400 | 1.0 | Not-occurred |

A small surface roughness of the nip portion forming member 68 is desirable to increase the advantageous effect of suppressing the non-sheet feeding area temperature rise. However, in the case where the surface roughness of the nip portion forming member 68 is too small, contact between the inner surface of the pressure film 66 and the surface of the nip portion forming member 68 is too closer and grease is less effective, and the slidability is reduced, thereby generating stick slip. As illustrated in Table 4, stick slip can be prevented by setting the arithmetic average surface roughness Ra of the nip portion forming member 68 to at least 0.5 μm.

TABLE 4

| | Surface | |
|---|---|---|
| Material of nip portion forming | roughness Ra | |
| member 68 | (μm) | Stick slip |
| Pure aluminum | 0.1 | Not-occurred |
| Pure aluminum (alumite treatment A) | 0.5 | Not-occurred |
| Pure aluminum (alumite treatment B) | 0.5 | Not-occurred |
| Pure aluminum (alumite treatment C) | 0.5 | Not-occurred |
| Pure aluminum (alumite treatment D) | 1.0 | Not-occurred |
| Pure aluminum (alumite treatment G) | 0.1 | Fair |
| Pure aluminum (alumite treatment H) | 0.05 | Fail (occurred) |

The desirable thickness of an oxide layer 68b is 50 μm or less. The nip portion forming member 68 may sometimes become a high temperature of a 200° C. at the maximum according to the non-sheet feeding area temperature rise. The coefficients of thermal expansion of the oxide layer 68b and the aluminum base member are different from each other. Accordingly, there is a possibility that the oxide layer 68b cannot follow expansion of the base layer 66a to cause a crack. As illustrated in Table 5, a crack after sheet feeding can be prevented by setting the thickness of the oxide layer 68b of the nip portion forming member 68 to 50 μm or less.

TABLE 5

| Material of nip portion forming | | Crack after sheet |
|---|---|---|
| member 68 | Thickness | feeding |
| Pure aluminum (alumite treatment C) | 5 | Not-occurred |
| Pure aluminum (alumite treatment D) | 10 | Not-occurred |
| Pure aluminum (alumite treatment E) | 20 | Not-occurred |
| Pure aluminum (alumite treatment F) | 50 | Not-occurred |
| Pure aluminum (alumite treatment G) | 75 | Fail (occurred) |

The nip portion forming member 68 of this embodiment is configured in consideration of the non-sheet feeding area temperature rise, abrasion (scraping) of the surface, stick slip, and suppression of a crack. Alumite treatment conditions are adjusted such that the nip portion forming member 68 made by forming the oxide layer 68b on pure aluminum with a thickness of 50 μm has a thermal conductivity in the thickness direction of 210 W/m·K, and a skewness Rsk of the roughness curve on the surface of −1.0, an arithmetic average surface roughness Ra of 0.5 μm, and a Vickers hardness of 400. Scraping due to sliding between the nip portion forming member 68 and the pressure film 66 is small, the slidability is favorable, and stick slip does not occur, no crack occurs in the oxide layer 68b after sheet feeding, and occurrence of the non-sheet feeding area temperature rise can be suppressed.

As described above, in this embodiment, occurrence of the non-sheet feeding area temperature rise can be suppressed, while reduction in slidability between the pressure film and the nip portion forming member is suppressed.

### Variation of Embodiment 1

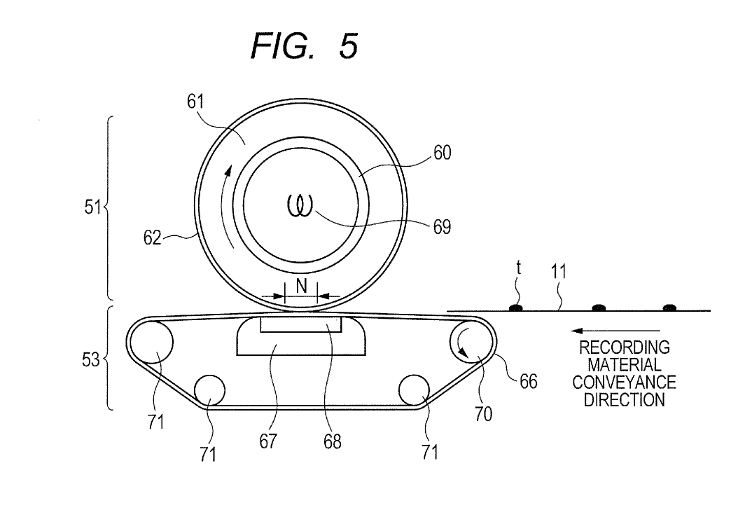

A variation of this embodiment will be described. FIG. 5 is a schematic cross-sectional view of a fixing unit 50 of a variation of this embodiment.

The fixing unit 50 described in this variation is different from the device of Embodiment 1 in that the heating film (belt) 66 is laid with a tension around a drive roller 70 and three tension rollers 71, and a halogen heater 69 involved in the fixing roller 51 is adopted as a heater.

The fixing roller 51 includes a hollow core metal 60. The core metal 60 internally includes a halogen heater 69. The fixing roller 51 is heated from the inside. Heat reaching the surface is conducted to the recording material 11.

The pressure film 66 is rotated in the direction of an arrow by the drive roller 70 so as to have a speed substantially equivalent to the speed of the fixing roller 51.

The nip portion forming member 68 is in contact with the inner surface of the pressure film 66, and presses the pressure film 66 toward the fixing roller 51. Thus, the nip portion forming member 68 forms a fixing nip portion N together with the fixing roller 51 via the pressure film 66.

The nip portion forming member 68 of this variation is a metal member including an oxide layer formed by an alumite treatment on a surface in contact with the inner surface of the belt as with Embodiment 1. The metal member is pure aluminum with an aluminum content percentage of at least 99.0 wt %. The oxide layer has a thickness of 50 μm or less.

This variation exerts the same advantageous effects as those of Embodiment 1.

The method of heating the fixing roller 51 is not limited to that of one of a ceramic heater and a halogen heater. The method may be an electromagnetic induction heating method.

A belt may be adopted instead of the fixing roller 51. The material of the pressure film 66 is not limited to polyimide. The material may be another material having heat resistance, such as one of polyamide, polyamide-imide and silicone resin instead.

### Embodiment 2

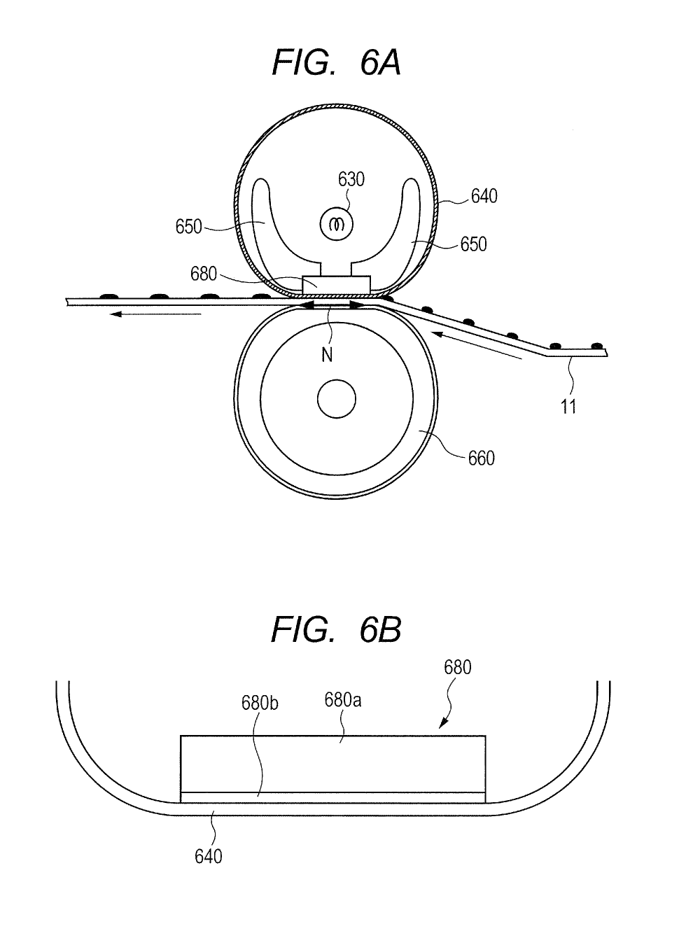

FIG. 6A illustrates a schematic cross-sectional view of a fixing unit of Embodiment 2. The fixing unit of Embodiment 2 includes: an endless film (belt) 640 in contact with a toner image; a nip portion forming member 680 in contact with the inner surface of the film 640; and a pressure roller 660 as a pressure component that forms the nip portion N together with the nip portion forming member 680 via the film 640. The fixing unit of this embodiment is different from the device of Embodiment 1 in that the device does not adopt external heating.

The film 640 includes: a base layer formed of polyimide resin; and a release layer that is formed of fluorocarbon polymer, such as PFA, on the peripheral surface of the base layer. The material of the base layer of the film 640 is not limited to polyimide. The material may be another material having heat resistance, such as one of polyamide, polyamide-imide and silicone resin. Furthermore, the fixing unit in Embodiment 2 includes: a halogen heater 630 that is involved in the film 640 and heats the inner surface of the film 640; and a film guide member 650 that supports the nip portion forming member 680 and guides the film 640. The recording material 11 bearing a toner image is heated at the nip portion N while being conveyed, and the toner image is fixed on the recording material 11.

A problem will be described in the case of adopting a nip portion forming member made of heat-resistant resin in the fixing unit as described above instead of the nip portion forming member 680 of this embodiment. When the sheet feeding area of the film 640 and the nip portion forming member is heated by heat of radiation of the halogen heater 630, the heat is absorbed by the recording material 11 through the film 640. Accordingly, the temperature is difficult to increase. Meanwhile, even if the non-sheet feeding area of the film 640 and the nip portion forming member is heated by heat of radiation of the halogen heater 630, heat is difficult to be uniformed in the nip portion forming member, and absorbed by the pressure roller 660. As accumulation of heat in the non-sheet feeding area of the pressure roller 660 is progressed, the non-sheet feeding area temperature rise of the film 640, the nip portion forming member and the pressure roller 660 is progressed. There is a problem of breakage due to exceeding the heat-resistant limit temperature of each component.

Furthermore, the nip portion forming member slides also on the inner surface of the film 640. Accordingly, the slidability between the nip portion forming member and the film 640 due to abrasion of the nip portion forming member unfortunately easily decreases.

Thus, the fixing unit of Embodiment 2 adopts the nip portion forming member 680 having the same configuration as that of Embodiment 1. FIG. 6B illustrates an enlarged cross-sectional view of the nip portion N of the fixing unit of Embodiment 2. The nip portion forming member 680 is a metal member having a surface which is in contact with the inner surface of the film 640 and on which an oxide layer 680b is formed by an alumite treatment. This embodiment adopts pure aluminum with an aluminum content percentage of at least 99.0 wt % for the metal member. A portion 680a having not been subjected to the alumite treatment is pure aluminum. The metal member may be an aluminum alloy instead of pure aluminum.

The oxide layer 680b has a thickness of 50 μm or less, and a Vickers hardness of at least 150. The arithmetic average roughness Ra on the surface of the oxide layer 680b is 1.0 μm or less. The skewness Rsk is −1.0 or less.

When images are successively formed on small-sized recording materials, adoption of the nip portion forming member 680 of this embodiment allows heat to flow from one non-sheet feeding area having a high temperature to another non-sheet feeding area having a lower temperature than the one non-sheet feeding area has, in the nip portion forming member, thereby uniformizing heat in the longitudinal direction. Accordingly, also in Embodiment 2, the non-sheet feeding area temperature rise of the fixing unit is suppressed as with Embodiment 1. Furthermore, the provided oxide layer can suppress reduction in slidability between the nip portion forming member and the film 640, as with Embodiment 1.

As described above, also in the configuration of the fixing unit in Embodiment 2, the advantageous effect of suppressing the non-sheet feeding area temperature rise while suppressing reduction in slidability between the nip portion forming member and the inner surface of the film can be obtained.

The fixing units of Embodiments 1 and 2 are not limited to be used as devices that fix unfixed toner images formed on recording materials on these recording materials. For instance, the devices can be also used for an image heating apparatus that heats an unfixed toner image to temporarily fix the image on a recording material, or an image heating apparatus that heats a toner image fixed on a recording material to put a shine on the surface of the toner image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-160326, filed Jul. 19, 2012, and Japanese Patent Application No. 2013-119773, filed Jun. 6, 2013, which are hereby incorporated by reference herein in their entirety.

What is claimed is:

1. An image heating apparatus for heating a toner image while conveying the recording material bearing the toner image at a nip portion comprising:
a rotary member configured to contact the toner image;
an endless belt; and
a nip portion forming member configured to contact with an inner surface of the belt and form the nip portion together with the rotary member through the belt,
wherein the nip portion forming member is made of metal whose surface which contacts the inner surface of the belt has an oxide layer formed by an alumite treatment.

2. An apparatus according to claim 1,
wherein the metal is pure aluminum with an aluminum content percentage of at least 99.0 wt %, and the oxide layer has a thickness of 50 μm or less.

3. The apparatus according to claim 1,
wherein the metal is an aluminum alloy, and the oxide layer has a thickness of 50 μm or less.

4. The apparatus according to claim 1,
wherein the oxide layer has a Vickers hardness of at least 150.

5. The apparatus according to claim 1,
wherein the oxide layer has an arithmetic average roughness Ra of 1.0 μm or less.

6. The apparatus according to claim 1,
wherein the belt is made of resin.

7. The apparatus according to claim 1,
wherein the oxide layer has a skewness Rsk of −1.0 or less.

8. The apparatus according to claim 1,
wherein the rotary member is a fixing roller.

9. The apparatus according to claim 8,
wherein the image heating apparatus includes an endless heating belt, and a heater in contact with the inner surface of the heating belt, and the heater forms a heating pressure area together with the fixing roller through the heating belt.

10. An image heating apparatus for heating a toner image while conveying a recording material bearing the toner image at a nip portion comprising:
an endless belt configured to contact the toner image;
a nip portion forming member configured to contact an inner surface of the belt; and
a pressure member forming the nip portion together with the nip portion forming member through the belt,
wherein the nip portion forming member is made of metal whose surface which contacts the inner surface of the belt has an oxide layer formed by an alumite treatment.

11. The apparatus according to claim 10,
wherein the metal is pure aluminum with an aluminum content percentage of at least 99.0 wt %, and the oxide layer has a thickness of 50 μm or less.

12. The apparatus according to claim 10,
wherein the metal is an aluminum alloy, and the oxide layer has a thickness of 50 μm or less.

13. The apparatus according to claim 10,
wherein the oxide layer has a Vickers hardness of at least 150.

14. The apparatus according to claim 10,
wherein the oxide layer has an arithmetic average roughness Ra of 1.0 μm or less.

15. The apparatus according to claim 10,
wherein the oxide layer has a skewness Rsk of −1.0 or less.

16. The apparatus according to claim 10,
wherein the image heating apparatus includes a halogen heater that is involved in the heating belt and heats the inner surface of the belt.
